(19) United States
(12) Patent Application Publication
(10) Pub. No.: US 2023/0103475 A1
(43) Pub. Date: Apr. 6, 2023

(54) Systems, Devices, and/or Methods for Fishing

(71) Applicant: Travis Swenson, Polson, MT (US)

(72) Inventor: Travis Swenson, Polson, MT (US)

(21) Appl. No.: 17/494,641

(22) Filed: Oct. 5, 2021

(51) Int. Cl. A01K 85/14

(52) U.S. Cl. CPC A01K 85/14

(57) ABSTRACT

Certain exemplary embodiments can provide a system that comprises a shell casing, a wire, a spoon, a first bead, a second bead, and a fishhook. The wire passes through an approximate center of the shell casing. The spoon is slidably coupled to the wire. The first bead is engaged with an aperture defined by a rearward rim surface of the shell casing. The second bead is engaged with an aperture defined by a slug end of the shell casing. The fishhook is coupled to a portion of the wire that extends from the slug end of the shell casing, wherein the fishhook protrudes from the slug end of the shell casing.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a side view of an exemplary embodiment of a system 1000;

FIG. 2 is an exploded view of system 1000;

FIG. 3 is a front view of an exemplary embodiment of a spoon 3000;

FIG. 4 is a rear view of a spoon 3000.

FIG. 5 is a side view of an exemplary embodiment of a .22 caliber shell casing 5000.

### DETAILED DESCRIPTION

Certain exemplary embodiments can provide a system that comprises a shell casing, a wire, a spoon, a first bead, a second bead, and a fishhook. The wire passes through an approximate center of the shell casing. The spoon is slidably coupled to the wire. The first bead is engaged with an aperture defined by a rearward rim surface of the shell casing (e.g., in the pocket space in which the primer for the cartridge would be seated). The second bead is engaged with an aperture defined by a slug end of the shell casing. The fishhook is coupled to a portion of the wire that extends from the slug end of the shell casing, wherein the fishhook protrudes from the slug end of the shell casing.

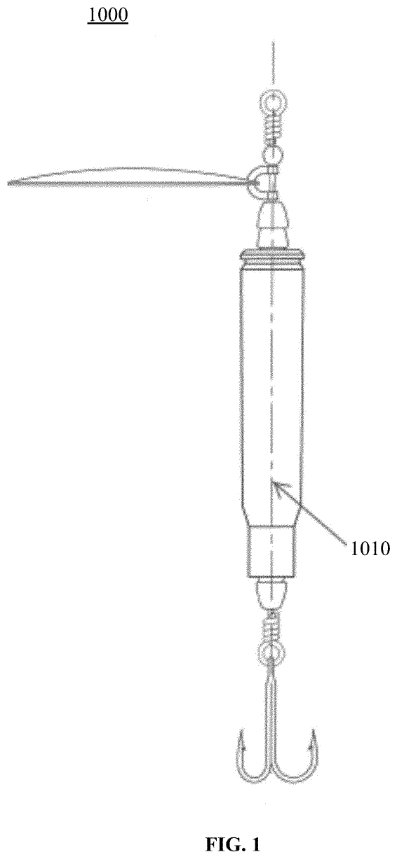

FIG. 1 is a side view of an exemplary embodiment of a system 1000, in which a centerline 1010 of system 1000 is illustrated.

System 1000 can have a variety of sizes and/or designs. Depending on shell size and blade style, beads and cone heads may vary with shell size and blade style. Optional materials are available such as nickel, chrome, brass, and/or substances with painted finishes.

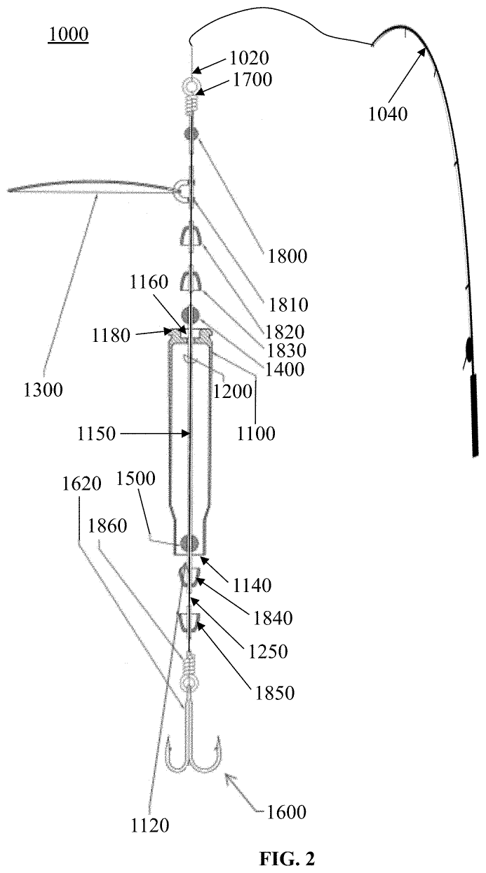

FIG. 2 is an exploded view of system 1000, which comprises:
a shell casing 1100;
a wire 1200, wire 1200 passing through a center 1150 of shell casing 1100;
a spoon 1300, spoon 1300 slidably coupled to the wire 1200, spoon 1300 can comprise a clevis 1810;
a first bead 1400, first bead 1400 engaged with a first aperture 1160 defined by a rearward rim surface 1180 of shell casing 1100;
a second bead 1500, second bead 1500 engaged with a second aperture 1140 defined by a slug end 1120 of shell casing 1100;
a fishhook 1600, fishhook 1600 coupled to a portion 1250 of wire 1200 that extends from slug end 1120 of shell casing 1100, fishhook 1600 comprises a shank 1620, wherein fishhook 1600 protrudes from slug end 1120 of shell casing 1100;
a first eyelet 1700, first eyelet 1700 coupled to wire 1200, first eyelet 1700 constructed to be coupled to a fishing line 1020 of a fishing pole 1040;
a third bead 1800, third bead 1800 slidably coupled to wire 1200, third bead 1800 located between first eyelet 1700 and spoon 1300;
a first cone head 1820 (although a cone head bead is illustrated, any shape or size of bead can be utilized); and
a second cone head 1830 (although a cone head bead is illustrated, any shape or size of bead can be utilized), wherein:
   first cone head 1820 and second cone head 1830 are slidably coupled to wire 1200; and
   first cone head 1820 and second cone head 1830 are located between spoon 1300 and first bead 1400;
a third cone head 1840 (although a cone head bead is illustrated, any shape or size of bead can be utilized); and
a fourth cone head 1850 (although a cone head bead is illustrated, any shape or size of bead can be utilized); and
a second eyelet 1860, wherein:
   third cone head 1840 and fourth cone head 1850 are slidably coupled to wire 1200;
   second eyelet 1860 is located between fishhook 1600 and fourth cone head 1850; and
   third cone head 1840 and fourth cone head 1850 are located between 1860 second eyelet and second bead 1500.

In certain exemplary embodiments, third bead 1800 can comprise chrome and/or brass. In certain exemplary embodiments, third bead 1800 can be approximately 0.125 inches in diameter. In certain exemplary embodiments, clevis 1810 can comprise nickel. In certain exemplary embodiments, first cone head 1820, second cone head 1830, third cone head 1840, and/or fourth cone head 1850 can have a length of approximately 0.1875 inches. In certain exemplary embodiments, first cone head 1820, second cone head 1830, third cone head 1840, and/or fourth cone head 1850 can comprise chrome and/or brass. In certain exemplary embodiments, first cone head 1820, second cone head 1830, third cone head 1840, and/or fourth cone head 1850 can be any shape or size of bead and might not have a cone head shape.

In certain exemplary embodiments, first bead 1400 can have a diameter of approximately 0.09375 inches. First bead 1400 can be sized to correspond to a diameter of first aperture 1160 defined by a rearward rim surface 1180 of shell casing 1100. In certain exemplary embodiments, shell casing 1100 can be a brass casing from a 30-06 round. Other calibers can be utilized. In certain exemplary embodiments, wire 1200 can be 20 gauge stainless wire.

In certain exemplary embodiments, second bead 1500 can have a diameter of approximately 0.09375 inches. Second bead 1500 can be sized to correspond to a diameter of second aperture 1140 defined by a slug end 1120 of shell casing 1100.

First bead 1400, second bead 1500, and/or any other bead described herein can have any shape or size.

In certain exemplary embodiments, second eyelet 1860 can comprise four or more wraps. In certain exemplary embodiments, fishhook 1600 can be a treble hook as illustrated. In other exemplary embodiments, fishhook 1600 can be a single barbed hook. Fishhook 1600 can vary in size and shape.

In certain exemplary embodiments, spoon 1300 can be a #6 Oklahoma spinner blade. Spoon 1300 can have any of a variety of shapes and sizes.

In certain exemplary embodiments, spoon 1300 rotates when pulled through water at a predetermined speed.

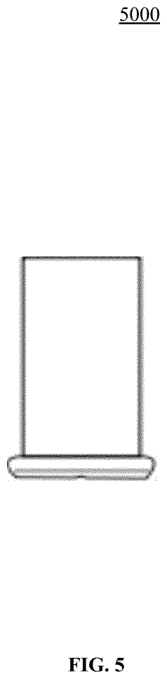

In certain exemplary embodiments, shell casing 1100 approximates a size and shape of a 0.22 caliber shell casing (see, e.g., .22 caliber shell casing 5000 of FIG. 5). In other exemplary embodiments, shell casing 1100 approximates a size and shape of a shell casing that is of a larger caliber than 0.22 caliber.

In certain exemplary embodiments, shell casing 1100 comprises brass. In other exemplary embodiments, shell casing 1100 comprises plastic.

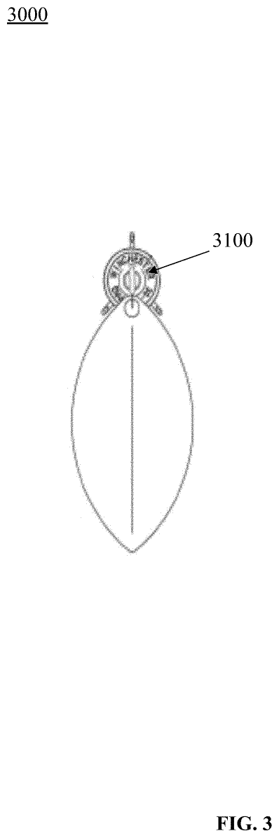

FIG. 3 is a front view of an exemplary embodiment of a spoon 3000, which can be utilized in systems such as system 1000 of FIG. 1 as spoon 1300. Spoon 3000 can comprise a logo 3100, which can be indicative of branding.

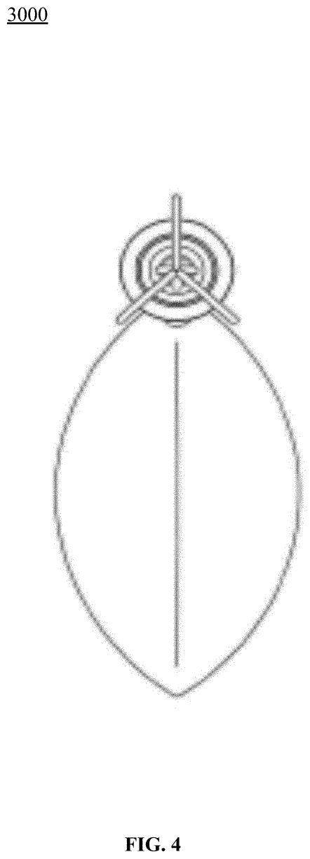

FIG. 4 is a rear view of spoon 3000.

FIG. 5 is a side view of an exemplary embodiment of a .22 caliber shell casing 5000.

Certain exemplary embodiments provide a fishing lure, which comprises an empty firearm ammunition shell casing and a fishhook coupled thereto. Water turbulence is achieved via dragging a rearward rim surface of the shell casing forward through water. Certain exemplary embodiments attract game fish when the lure is submerged during use. The fishhook is fixedly coupled to a slug end of the shell casing and protrudes therefrom. A spoon and/or other decorative lure components can be coupled to the shell casing.

The fishing lure comprises an empty ammunition cartridge or shell casing for a firearm, such as a rifle or handgun. The shell casing can be pristine (i.e., never fired) or can be a spent casing which remains after having been fired from a firearm.

In certain exemplary embodiments, the shell casing comprises brass. In certain exemplary embodiments, the shell casing can comprise a rigid plastic material. Thus, as used herein and in the accompanying claims, the term “shell casing” refers to an object with a generally cylindrical body having an enlarged diameter rim which substantially closes one end opposite to an open end thereof (except for the primer pocket) and which is adapted to be used as, or which simulates, firearms ammunition. The shell casing may thus be made of virtually any rigid metal or plastics material.

The fishing lure can comprise a number of optional structures to suit specific fishing situations and/or game fish. For example, the fishing lure can comprise a metallic or plastic spoon body, which is fixedly coupled to the shell casing.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.

0.22 caliber—constructed for use in a firearm having a bore diameter of approximately 0.22 inch (5.6 mm).

a—at least one.

activity—an action, act, step, and/or process or portion thereof

adapter—a device used to effect operative compatibility between different parts of one or more pieces of an apparatus or system.

and/or—either in conjunction with or in alternative to.

apparatus—an appliance or device for a particular purpose.

approximate—substantially exact.

bead—a small piece of material that defines an aperture such that the bead can be slidably coupled to a string or wire.

brass—comprising copper and zinc.

associate—to join, connect together, and/or relate.

can—is capable of, in at least some embodiments.

cause—to produce an effect.

center—a middle point of an object that is approximately equidistant from points on a surface of the object.

comprising—including but not limited to.

cone head—a bead having any shape, which might be a bead having a shape of a truncated cylindrical cone.

configure—to make suitable or fit for a specific use or situation.

connect—to join or fasten together.

constructed to—made to and/or designed to.

convert—to transform, adapt, and/or change.

couple—to physically join in some fashion.

coupleable—capable of being joined, connected, and/or linked together.

create—to bring into being.

define—to establish the outline, form, or structure of

device—a machine, manufacture, and/or collection thereof.

engage—to be in contact and interact with.

extend—to continue in a specified direction.

eyelet—a rigid component that is coupleable to a wire, wherein the component defines a small aperture, the small aperture constructed to receive a fishing line or a wire.

fishhook—a curved object of metal that comprises at least one pointed end, which curved object that is constructed to be coupled to an end of a piece of fishing line to catch fish.

fishing line—a cord coupled to a hook and constructed for use in fishing.

fishing pole—a rod with a line attached to, or extending from, a tip of the rod constructed for use in fishing.

install—to connect or set in position and prepare for use.

larger—bigger in size.

located—positioned.

may—is allowed and/or permitted to, in at least some embodiments.

method—a process, procedure, and/or collection of related activities for accomplishing something.

pass through—to enter one side and exit out of an opposite or another side of something.

plastic—comprising one or more of any of numerous organic synthetic or processed materials that are mostly thermoplastic or thermosetting polymers of high molecular weight and that can be made into objects, films, or filaments.

portion—a part of a whole.

predetermined—established in advance.

protrude—to extend beyond or above a surface.

provide—to furnish, supply, give, and/or make available.

pull—to exert force upon so as to tug at something.

receive—to get, take, acquire, and/or obtain.

rearward rim surface—an edge of a shell casing that either (1) defines an aperture in which a primer can be coupled to the shell casing, or (2) has a rim constructed to ignite a charge in the shell casing when the rim is struck by a hammer of a firearm.

rotate—to move or cause to move around an axis or center.

round—a unit of ammunition.

set—a related plurality.

shape—a spatial form.

shell casing—a part of a round of ammunition that comprises a primer and propellant powder, which propellant powder causes discharge a slug from the shell casing when the round is fired from a firearm.

size—to have a predetermined set of dimensions.

slide—to move along a surface.

slug end—a portion of a shell casing to which a slug is coupled in armed rounds.

speed—a linear velocity.

spoon—a blade of a fishing lure that resembles a spoon in shape (i.e., having a concave side and an opposing convex side).

store—to place, hold, and/or retain.

substantially—to a great extent or degree.

support—to bear the weight of, especially from below.

system—a collection of mechanisms, devices, machines, articles of manufacture, processes, data, and/or instructions, the collection designed to perform one or more specific functions.

through—moving from a first position to a second position in something.

transmit—to send, provide, furnish, and/or supply.

via—by way of and/or utilizing.

wire—metal drawn out into the form of a thin flexible thread or rod

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
a shell casing;
a wire, the wire passing through an approximate center of the shell casing;
a spoon, the spoon slidably coupled to the wire;
a first bead, the first bead engaged with a first aperture defined by a rearward rim surface of the shell casing;
a second bead, the second bead engaged with a second aperture defined by a slug end of the shell casing; and
a fishhook, the fishhook coupled to a portion of the wire that extends from the slug end of the shell casing, wherein the fishhook protrudes from the slug end of the shell casing.

2. The system of claim 1, further comprising:
an eyelet, the eyelet coupled to the wire, the eyelet constructed to be coupled to a fishing line of a fishing pole.

3. The system of claim 1, further comprising:
an eyelet, the eyelet coupled to the wire, the eyelet constructed to be coupled to a fishing line of a fishing pole; and
a third bead, the third bead slidably coupled to the wire, the third bead located between the eyelet and the spoon.

4. The system of claim 1, further comprising:
a first cone head; and
a second cone head, wherein:
the first cone head and the second cone head are slidably coupled to the wire; and
the first cone head and the second cone head are located between the spoon and the first bead.

5. The system of claim 1, further comprising:
a first cone head; and
a second cone head, wherein:
the first cone head and the second cone head are slidably coupled to the wire; and
the first cone head and the second cone head are located between the fishhook and the second bead.

6. The system of claim 1, further comprising:
first cone head; and
a second cone head; and
an eyelet, wherein:
the first cone head and the second cone head are slidably coupled to the wire;
the eyelet is located between the fishhook and the second cone head; and
the first cone head and the second cone head are located between the eyelet and the second bead.

7. The system of claim 1, wherein:
the spoon rotates when pulled through water at a predetermined speed.

8. The system of claim 1, wherein:
the shell casing approximates a size and shape of a 0.22 caliber round.

9. The system of claim 1, wherein:
the shell casing approximates a size and shape of a round that is of a larger caliber than 0.22 caliber.

10. The system of claim 1, wherein:
the shell casing comprises brass.

11. The system of claim 1, wherein:
the shell casing comprises plastic.

12. The system of claim 1, wherein:
the shell casing comprises nickel.

13. A system comprising:
a shell casing;
a wire, the wire passing through a center of the shell casing;
a spoon, the spoon slidably coupled to the wire;
a first bead, the first bead engaged with a first aperture defined by a rearward rim surface of the shell casing;
a second bead, the second bead engaged with a second aperture defined by a slug end of the shell casing;
a fishhook, the fishhook coupled to a portion of the wire that extends from the slug end of the shell casing, wherein the fishhook protrudes from the slug end of the shell casing;
a first eyelet, the first eyelet coupled to the wire, the first eyelet constructed to be coupled to a fishing line of a fishing pole;
a third bead, the third bead slidably coupled to the wire, the third bead located between the first eyelet and the spoon;
a first cone head; and
a second cone head, wherein:
the first cone head and the second cone head are slidably coupled to the wire; and
the first cone head and the second cone head are located between the spoon and the first bead;
a third cone head; and
a fourth cone head; and
a second eyelet, wherein:
the third cone head and the fourth cone head are slidably coupled to the wire;
the second eyelet is located between the fishhook and the fourth cone head; and
the third cone head and the fourth cone head are located between the second eyelet and the second bead.
